(19) United States
(12) Patent Application Publication
(10) Pub. No.: US 2022/0004820 A1
(43) Pub. Date: Jan. 6, 2022

(54) METHOD AND SYSTEM FOR ASSISTING A DEVELOPER IN IMPROVING AN ACCURACY OF A CLASSIFIER

(71) Applicant: Telepathy Labs, Inc., Tampa, FL (US)

(72) Inventor: Joram Meron, Zurich (CH)

(21) Appl. No.: 17/436,281

(22) PCT Filed: Mar. 3, 2020
(86) PCT No.: PCT/US2020/020801

§ 371 Date: Sep. 3, 2021

Related U.S. Application Data
(60) Provisional application No. 62/814,551, filed on Mar. 6, 2019.

(51) Int. Cl. G06K 9/62; G06N 3/08

(52) U.S. Cl. CPC G06K 9/6263; G06K 9/6228; G06N 3/08; G06K 9/6268; G06K 9/628; G06K 9/6232

(57) ABSTRACT

A method and a system for assisting a developer in improving an accuracy of a classification model or a classification process is disclosed. One or more features from the classification model or an example set may be selected and one or more values for the one or more features selected may be extracted. At least one correlation of the one or more features may be determined with a set of classes, respectively. Further, at least one diagnostic example for the correlation may be generated. The at least one diagnostic example may require the developer to one of validate and invalidate a correctness of the correlation produced by the at least one diagnostic

### CROSS-REFERENCE TO RELATED APPLICATION

This application claims the benefit of U.S. Provisional Patent Application Ser. No. 62/814,551, filed on Mar. 6, 2019 and entitled “Method and System for Assisting a Developer in Improving an Accuracy of a Classifier”. The contents of which is incorporated herein by reference.

### BACKGROUND

A classifier may require a training set to classify any type of data. The training set may include a plurality of classes and respective examples based upon which the classifier may be configured to perform data classification. Therefore, an accuracy of the classifier may depend on the quality of the training set. For example, if the training set lacks examples of a relevant characteristic of any of its target class, the classifier may not accurately classify the data. As another example, if the training set includes images of boats in water and images of cows in meadows, the classifier may learn that any picture with water in background is a boat, and thus may miss-classify a photo of a cow in water as the boat. In another example, if the training set includes sentences such as “where is a good place to eat pizza?”, “where can I get pizza?”, for a pizza intent; then the classifier may learn that sentences with the word “where” belong to the pizza intent.

### BRIEF SUMMARY OF DISCLOSURE

The present disclosure may include but is not limited to a computer implemented method, a computer readable storage medium, and a system for assisting the developer in improving an accuracy of a classification model.

In one example implementation, the computer implemented method may comprise providing, by a computing device, the classification model including a plurality of features corresponding with a set of classes. One or more features of the plurality of features may correspond with at least one class of the set of classes. The method may include selection of the one or more features of the plurality of features. The method may further include extraction of the one or more values for the one or more features selected. At least one correlation of the one or more features may be determined with the set of classes respectively. Further, the method may include generating at least one diagnostic example for the correlation. The at least one diagnostic example may require the developer to one of validate and invalidate a correctness of the correlation produced by the at least one generated diagnostic example.

One or more of the following example features may be included. The classification model may be created from a provided training set. In another example, the classification model may be a pre-trained model. Selecting the one or more features may be based on, at least in part, a location of the one or more features in a neural network. In another example, selecting the one or more features may be based on, at least in part, a received input selection from the developer. Determining the at least one correlation may include computing the at least one correlation over a set of examples. In another example, determining the at least one correlation may include extracting the at least one correlation from the classification model. The method may further include selecting the at least one correlation among a plurality of correlations based on a highest correlation value. The at least one diagnostic example may be one of at least one text-based question, at least one image-based question, at least one audio-based question, at least one video-based question, and at least one data-based question for the developer to one of validate and invalidate the correctness of the correlation produced. In another example, generating the at least one diagnostic example may include accessing a plurality of examples within a training set, extracting the one or more features for each example of the plurality of examples, and generating the at least one diagnostic example in accordance with the extracted features. In an example, a neural network may be used for the determining the at least one correlation and the neural network may be used to select the at least one correlation used for generating the at least one diagnostic example. Each of the one or more features may include at least one of a word, a part of a word, a phrase, a sentence, a paragraph, a combination of words, a portion of an image, a portion of an audio, a portion of a video, and a portion of data. The method may further include receiving an input from the developer that one of validates and invalidates the correctness of the correlation in response to the at least one diagnostic example. The method may further include when the developer invalidates the correctness of the correlation selected, recommending the developer provide an additional set of examples used as training data for adjusting the classification model to suppress the correlation selected between the one or more features selected and the set of classes, and receiving the additional set of examples. In an example, when the developer invalidates the correctness of the correlation selected, automatically generating an additional set of examples used as training data for adjusting the classification model to suppress the correlation selected between the one or more features selected and the set of classes. In an example, when the developer invalidates the correctness of the correlation selected, automatically generating an additional set of examples and recommending at least one of the developer revise and approve the additional set of examples such that the additional set of examples are used as training data for adjusting the classification model to suppress the correlation selected between the one or more features selected and the set of classes. In an example, when the developer invalidates the correctness of the correlation selected, adjusting the classification model by modifying at least one parameter of the classification model. The method may further include re-determining the at least one correlation of the one or more features selected upon adjusting the classification model. The classification model may be a neural network classification model. The method may further include iteratively generating another diagnostic example for the developer for another correlation selected from the at least one correlation. The another diagnostic example may require the developer to one of validate and invalidate the correctness of another correlation produced by the another diagnostic example.

In another example implementation, a computer-implemented method for assisting a developer in improving an accuracy of a classification process is disclosed. The computer-implemented method may comprise providing an example set. A plurality of features from the example set may be extracted. One or more features of the plurality of features may correspond with at least one class of a set of classes. The one or more features of the plurality of features may be selected. The method may include determining at least one correlation of the one or more features with the set of classes respectively. Further, the method may include generating at least one diagnostic example for the correlation. The at least one diagnostic example may require the developer to one of validate and invalidate a correctness of the correlation produced by the at least one diagnostic example.

In another example implementation, a system for assisting a developer in improving an accuracy of a classification model is disclosed. The system may comprise the classification model that may include a plurality of features corresponding with a set of classes. One or more features of the plurality of features may correspond with at least one class of the set of classes. The system may include a feature selector configured to select the one or more features of the plurality features. The system may include a feature extractor for extracting one or more values for the one or more features. Further, the system may include a correlation engine configured to determine at least one correlation of the one or more features with the set of classes respectively. The system may include a diagnostic engine configured to generate at least one diagnostic example for the correlation. The at least one diagnostic example may require the developer to one of validate and invalidate a correctness of the correlation produced by the at least one diagnostic example.

One or more of the following example features may be included. The diagnostic engine may be further configured to iteratively generate another diagnostic example for the developer for another correlation selected from the at least one correlation. The another diagnostic example may require the developer to at least one of validate and invalidate the correctness of another correlation produced by the another diagnostic example. The diagnostic engine may be further configured to generate at least one of a text-based question, at least one image-based question, at least one audio-based question, at least one video-based question, and at least one data-based question for the developer to one of validate and invalidate the correctness of the correlation. Each feature of the one or more features may include at least one of a word, a part of a word, a phrase, a sentence, a paragraph, a combination of words, a portion of an image, a portion of an audio, a portion of a video, and a portion of data. The system may further include an input interface for receiving an input from the developer that one of validates and invalidates the correctness of the correlation in response to the at least one diagnostic example. The system may include a recommendation engine configured to recommend the developer to provide an additional set of a plurality of examples used as training data for adjusting the classification model to suppress the correlation selected between the one or more features selected and the set of classes when the developer invalidates the correctness of the correlation selected. In an example, the system may include a recommendation engine that may be configured to automatically generate an additional set of a plurality of examples used as training data for adjusting the classification model to suppress the correlation selected between the one or more features selected and the set of classes when the developer invalidates the correctness of the correlation selected.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the disclosure. Of the drawings:

FIG. 1 is an example diagrammatic view of an accuracy improvement process coupled to an example distributed computing network, according to one or more example implementations of the disclosure;

FIG. 2 is an example diagrammatic view of a client electronic device of FIG. 1, according to one or more example implementations of the disclosure;

FIG. 3 is a block diagram of a system for assisting a developer in improving an accuracy of a classification model in accordance with an example embodiment of the disclosure;

FIG. 4 is an example flowchart of an accuracy improvement process for assisting a developer in improving an accuracy of a classification model according to one or more example implementations of the disclosure;

FIG. 5 is another example flowchart of an accuracy improvement process for adjusting a classification model according to one or more example implementations of the disclosure; and

FIG. 6 is an example flowchart of an accuracy improvement process for assisting a developer in improving an accuracy of a classification model according to one or more example implementations of the disclosure.

Like reference symbols in the various drawings indicate like elements.

### DETAILED DESCRIPTION

### System and Process Overview:

For some examples, if the training set is of a relatively small size and/or if the accuracy of the classifier is below a threshold level, typically, developers may then add examples to the training set to resolve this issue. However, for example, if the developer is not aware of the reason for the inaccuracy of the classifier (e.g., inaccurate classification by the classifier), the process of adding further examples may not improve the accuracy of the classifier. As a result, a manual intervention by the developers in the training set may be an inefficient and ineffectual process. Furthermore, it may be relatively difficult for the developer to determine missing characteristics in the training set and decision-making process of the classifier. Consequently, the manual intervention by the developers may become a trial and error process that does not provide a robust mechanism to improving the accuracy of the classifier.

Accordingly, a process, computer readable medium, and/or a system may be advantageous for assisting the developers in improving the accuracy of the classifier.

Example embodiments of the present disclosure address the example problem of the processes by rendering insights on incompleteness of the training set. These example embodiments bring forth an absence of a plurality of characteristics in the training set to the developers so that the necessary action(s) may be taken. For example, the example embodiments may automatically generate diagnostic examples and present the diagnostic examples to the developers. Based on the response of the developers on the diagnostic examples, the example embodiments may identify absent characteristics in the training set. Subsequently, the example embodiments may add additional examples that can compensate for the absent characteristics in the training set. Alternatively, the example embodiments may include recommendations to the developers to add examples in the training set corresponding to the absent characteristics in the training set.

The methods and systems described in the present disclosure may automatically generate diagnostic examples. As a result, the developers may understand the decision process of a classification model, and thus detect in advance (e.g., before releasing the classification model to production) wrong decisions by the classification model. These diagnostic examples may support the developer in understanding what kind of examples are to be added to the training set. The diagnostic examples may enable the developer to understand that the training set is not balanced, or that the distribution of some words is unintentionally biased. Accordingly, the developer may add examples which can balance the training set and thereby, increase the accuracy of the classification model.

In some implementations, the present disclosure may be embodied as a method, system, or computer program product. Accordingly, in some implementations, the present disclosure may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, in some implementations, the present disclosure may take the form of a computer program product on a computer-usable storage medium having computer-usable program code embodied in the medium.

In some implementations, any suitable computer usable or computer readable medium (or media) may be utilized. The computer readable medium may be a computer readable signal medium or a computer readable storage medium. The computer-usable, or computer-readable, storage medium (including a storage device associated with a computing device or client electronic device) may be, for example, but is not limited to, an electronic, magnetic, optical, electromagnetic, infrared, or semiconductor system, apparatus, device, or any suitable combination of the foregoing. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a digital versatile disk (DVD), a static random access memory (SRAM), a memory stick, a floppy disk, a mechanically encoded device such as punch-cards or raised structures in a groove having instructions recorded thereon, a media such as those supporting the internet or an intranet, or a magnetic storage device. Note that the computer-usable or computer-readable medium could even be a suitable medium upon which the program is stored, scanned, compiled, interpreted, or otherwise processed in a suitable manner, if necessary, and then stored in a computer memory. In the context of the present disclosure, a computer-usable or computer-readable, storage medium may be any tangible medium that can contain or store a program for use by or in connection with the instruction execution system, apparatus, or device.

In some implementations, a computer readable signal medium may include a propagated data signal with computer readable program code embodied therein, for example, in baseband or as part of a carrier wave. In some implementations, such a propagated signal may take any of a variety of forms, including, but not limited to, electro-magnetic, optical, or any suitable combination thereof. In some implementations, the computer readable program code may be transmitted using any appropriate medium, including but not limited to the internet, wireline, optical fiber cable, RF, etc. In some implementations, a computer readable signal medium may be any computer readable medium that is not a computer readable storage medium and that can communicate, propagate, or transport a program for use by or in connection with an instruction execution system, apparatus, or device.

In some implementations, computer program code for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java®, Smalltalk, C++ or the like. Java and all Java-based trademarks and logos are trademarks or registered trademarks of Oracle and/or its affiliates. However, the computer program code for carrying out operations of the present disclosure may also be written in example procedural programming languages, such as the “C” programming language, PASCAL, or similar programming languages, as well as in scripting languages such as JavaScript, PERL, or Python. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the internet using an Internet Service Provider). In some implementations, electronic circuitry including, for example, programmable logic circuitry, field-programmable gate arrays (FPGAs) or other hardware accelerators, micro-controller units (MCUs), or programmable logic arrays (PLAs) may execute the computer readable program instructions/code by utilizing state information of the computer readable program instructions to personalize the electronic circuitry, in order to perform aspects of the present disclosure.

In some implementations, the flowchart and block diagrams in the figures show the architecture, functionality, and operation of possible implementations of apparatus (systems), methods and computer program products according to various implementations of the present disclosure. Each block in the flowchart and/or block diagrams, and combinations of blocks in the flowchart and/or block diagrams, may represent a module, segment, or portion of code, which comprises one or more executable computer program instructions for implementing the specified logical function(s)/act(s). These computer program instructions may be provided to a processor of a general purpose computer, special purpose computer, or other programmable data processing apparatus to produce a machine, such that the computer program instructions, which may execute via the processor of the computer or other programmable data processing apparatus, create the ability to implement one or more of the functions/acts specified in the flowchart and/or block diagram block or blocks or combinations thereof. It should be noted that, in some implementations, the functions noted in the block(s) may occur out of the order noted in the figures. For example, two blocks illustrated in succession may, in fact, be executed substantially concurrently, or the blocks may sometimes be executed in the reverse order, depending upon the functionality involved.

In some implementations, these computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks or combinations thereof.

In some implementations, the computer program instructions may also be loaded onto a computer or other programmable data processing apparatus to cause a series of operational steps to be performed (not necessarily in a particular order) on the computer or other programmable apparatus to produce a computer implemented process such that the instructions which execute on the computer or other programmable apparatus provide steps for implementing the functions/acts (not necessarily in a particular order) specified in the flowchart and/or block diagram block or blocks or combinations thereof.

Further, skilled artisans will appreciate that elements in the drawings are shown for simplicity and may not have been necessarily been drawn to scale. For example, the flow charts show the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having benefit of the description herein.

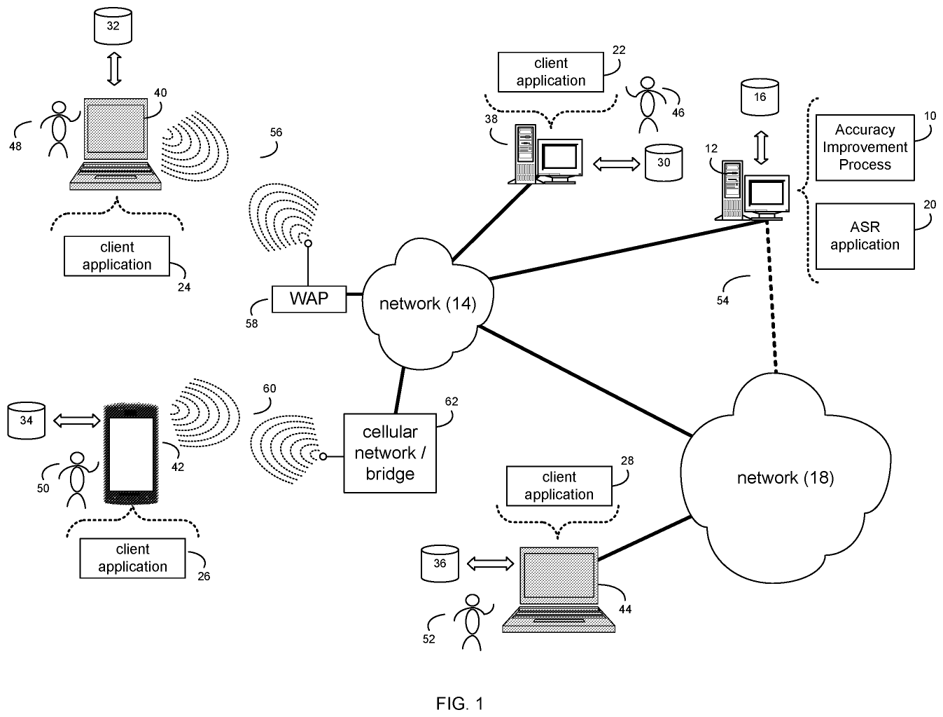

Referring now to the example implementation of FIG. 1, there is shown an accuracy improvement process 10 that may reside on and may be executed by a computer (e.g., computer 12), which may be connected to a network (e.g., network 14) (e.g., the internet or a local area network). Examples of computer 12 (and/or one or more of the client electronic devices noted below) may include, but are not limited to, a personal computer(s), a laptop computer(s), mobile computing device(s), a server computer, a series of server computers, a mainframe computer(s), or a computing cloud(s). In some implementations, each of the aforementioned may be generally described as a computing device. In certain implementations, a computing device may be a physical or virtual device. In many implementations, a computing device may be any device capable of performing operations, such as a dedicated processor, a portion of a processor, a virtual processor, a portion of a virtual processor, portion of a virtual device, or a virtual device. In some implementations, a processor may be a physical processor or a virtual processor. In some implementations, a virtual processor may correspond to one or more parts of one or more physical processors. In some implementations, the instructions/logic may be distributed and executed across one or more processors, virtual or physical, to execute the instructions/logic. Computer 12 may execute an operating system, for example, but not limited to, Microsoft® Windows®; Mac® OS X®; Red Hat® Linux®, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

In some implementations, as will be discussed below in greater detail, an accuracy improvement process, such as the accuracy improvement process 10 of FIG. 1, may assist the developer in improving an accuracy of a classification model. The accuracy improvement process may comprise providing the classification model including a plurality of features corresponding with a set of classes. One or more features may correspond with at least one class of the set of classes. The process may include selection of one or more features of the plurality of features. The process may further include extraction of values for the selected one or more features. At least one correlation of the selected one or more features may be determined with the set of classes respectively. Further, the process may include generating at least one diagnostic example for the selected correlation. The at least one diagnostic example may require the developer to validate or invalidate a correctness of the selected correlation produced (or represented) by the at least one diagnostic example.

In some implementations, the instruction sets and subroutines of the accuracy improvement process 10, which may be stored on storage device, such as storage device 16, coupled to computer 12, may be executed by one or more processors and one or more memory architectures included within computer 12. In some implementations, storage device 16 may include but is not limited to: a hard disk drive; a flash drive, a tape drive; an optical drive; a RAID array (or other array); a random access memory (RAM); and a read-only memory (ROM).

In some implementations, network 14 may be connected to one or more secondary networks (e.g., network 18), examples of which may include but are not limited to: a local area network; a wide area network; or an intranet, for example.

In some implementations, computer 12 may include a data store, such as a database (e.g., relational database, object-oriented database, triplestore database, etc.) and may be located within any suitable memory location, such as storage device 16 coupled to computer 12. In some implementations, data, metadata, information, etc. described throughout the present disclosure may be stored in the data store. In some implementations, computer 12 may utilize any known database management system such as, but not limited to, DB2, in order to provide multi-user access to one or more databases, such as the above noted relational database. In some implementations, the data store may also be a custom database, such as, for example, a flat file database or an XML database. In some implementations, any other form(s) of a data storage structure and/or organization may also be used. In some implementations, the accuracy improvement process 10 may be a component of the data store, a standalone application that interfaces with the above noted data store and/or an applet/application that is accessed via client applications 22, 24, 26, 28. In some implementations, the above noted data store may be, in whole or in part, distributed in a cloud computing topology. In this way, computer 12 and storage device 16 may refer to multiple devices, which may also be distributed throughout the network.

In some implementations, computer 12 may execute an automatic speech recognition (e.g., automatic speech recognition (ASR) application 20), examples of the automatic speech recognition application or examples of one or more components of the automatic speech recognition application may include, but are not limited to, e.g., an automatic speech recognition (ASR) application (e.g., modeling, training, classification, etc.), a natural language understanding (NLU) application (e.g., machine learning, intent discovery, etc.), a text to speech (TTS) application (e.g., context awareness, learning, etc.), a speech signal enhancement (SSE) application (e.g., multi-zone processing/beamforming, noise suppression, etc.), a voice biometrics/wake-up-word processing application, or other application that allows for ASR functionality or for assistance to the developer in improving an accuracy of a classification model. In some examples, the ASR application 20 may include, but is not limited to, e.g., a class classifier, a diagnostic engine, a correlation engine, a recommendation engine, a feature extractor, a feature selector, a classification model, input interface, etc. In some implementations, the accuracy improvement process 10 and/or automatic speech recognition application 20 may be accessed via one or more of client applications 22, 24, 26, 28. In some implementations, the accuracy improvement process 10 may be a standalone application, or may be an applet/application/script/extension that may interact with and/or be executed within automatic speech recognition application 20, a component of automatic speech recognition application 20, and/or one or more of client applications 22, 24, 26, 28. In some implementations, automatic speech recognition application 20 may be a standalone application, or may be an applet/application/script/extension that may interact with and/or be executed within the accuracy improvement process 10, a component of the accuracy improvement process 10, and/or one or more of client applications 22, 24, 26, 28. In some implementations, one or more of client applications 22, 24, 26, 28 may be a standalone application, or may be an applet/application/script/extension that may interact with and/or be executed within and/or be a component of the accuracy improvement process 10 and/or automatic speech recognition application 20. Examples of client applications 22, 24, 26, 28 may include, but are not limited to, e.g., a class classifier, a diagnostic engine, a correlation engine, a recommendation engine, a feature extractor, a feature selector, a classification model, an input interface, an ASR application (e.g., modeling, training, classification, etc.), a natural language understanding (NLU) application (e.g., machine learning, intent discovery, etc.), a text to speech (TTS) application (e.g., context awareness, learning, etc.), a speech signal enhancement (SSE) application (e.g., multi-zone processing/beamforming, noise suppression, etc.), a voice biometrics/wake-up-word processing application, or other application that allows for ASR functionality or for assistance to the developer in improving an accuracy of a classification model, a standard and/or mobile web browser, an email application (e.g., an email client application), a textual and/or a graphical user interface, a customized web browser, a plugin, an Application Programming Interface (API), or a custom application. The instruction sets and subroutines of client applications 22, 24, 26, 28, which may be stored on storage devices 30, 32, 34, 36, coupled to client electronic devices 38, 40, 42, 44, may be executed by one or more processors and one or more memory architectures incorporated into client electronic devices 38, 40, 42, 44.

In some implementations, one or more of storage devices 30, 32, 34, 36, may include but are not limited to: hard disk drives; flash drives, tape drives; optical drives; RAID arrays; random access memories (RAM); and read-only memories (ROM). Examples of client electronic devices 38, 40, 42, 44 (and/or computer 12) may include, but are not limited to, a personal computer (e.g., client electronic device 38), a laptop computer (e.g., client electronic device 40), a smart/data-enabled, cellular phone (e.g., client electronic device 42), a notebook computer (e.g., client electronic device 44), a tablet, a server, a television, a smart television, a media (e.g., video, photo, etc.) capturing device, and a dedicated network device. Client electronic devices 38, 40, 42, 44 may each execute an operating system, examples of which may include but are not limited to, Android™, Apple® iOS®, Mac® OS X®; Red Hat® Linux®, or a custom operating system.

In some implementations, one or more of client applications 22, 24, 26, 28 may be configured to effectuate some or all of the functionality of the accuracy improvement process 10 (and vice versa). Accordingly, in some implementations, the accuracy improvement process 10 may be a purely server-side application, a purely client-side application, or a hybrid server-side/client-side application that is cooperatively executed by one or more of client applications 22, 24, 26, 28 and/or the accuracy improvement process 10.

In some implementations, one or more of client applications 22, 24, 26, 28 may be configured to effectuate some or all of the functionality of automatic speech recognition application 20 (and vice versa). Accordingly, in some implementations, automatic speech recognition application 20 may be a purely server-side application, a purely client-side application, or a hybrid server-side/client-side application that is cooperatively executed by one or more of client applications 22, 24, 26, 28 and/or automatic speech recognition application 20. As one or more of client applications 22, 24, 26, 28, the accuracy improvement process 10, and automatic speech recognition application 20, taken singly or in any combination, may effectuate some or all of the same functionality, any description of effectuating such functionality via one or more of client applications 22, 24, 26, 28, the accuracy improvement process 10, automatic speech recognition application 20, or combination thereof, and any described interaction(s) between one or more of client applications 22, 24, 26, 28, the accuracy improvement process 10, automatic speech recognition application 20, or combination thereof to effectuate such functionality, should be taken as an example only and not to limit the scope of the disclosure.

In some implementations, one or more of users 46, 48, 50, 52 may access computer 12 and the accuracy improvement process 10 (e.g., using one or more of client electronic devices 38, 40, 42, 44) directly through network 14 or through secondary network 18. Further, computer 12 may be connected to network 14 through secondary network 18, as shown with phantom link line 54. The accuracy improvement process 10 may include one or more user interfaces, such as browsers and textual or graphical user interfaces, through which users 46, 48, 50, 52 may access the accuracy improvement process 10.

In some implementations, the various client electronic devices may be directly or indirectly coupled to network 14 (or network 18). For example, client electronic device 38 is shown directly coupled to network 14 via a hardwired network connection. Further, client electronic device 44 is shown directly coupled to network 18 via a hardwired network connection. Client electronic device 40 is shown wirelessly coupled to network 14 via wireless communication channel 56 established between client electronic device 40 and wireless access point (i.e., WAP) 58, which is shown directly coupled to network 14. WAP 58 may be, for example, an IEEE 802.11a, 802.11b, 802.11g, Wi-Fi®, RFID, and/or Bluetooth™ (including Bluetooth™ Low Energy) device that is capable of establishing wireless communication channel 56 between client electronic device 40 and WAP 58. Client electronic device 42 is shown wirelessly coupled to network 14 via wireless communication channel 60 established between client electronic device 42 and cellular network/bridge 62, which is shown directly coupled to network 14.

In some implementations, some or all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. Bluetooth™ (including Bluetooth™ Low Energy) is a telecommunications industry specification that allows, e.g., mobile phones, computers, smart phones, and other electronic devices to be interconnected using a short-range wireless connection. Other forms of interconnection (e.g., Near Field Communication (NFC)) may also be used.

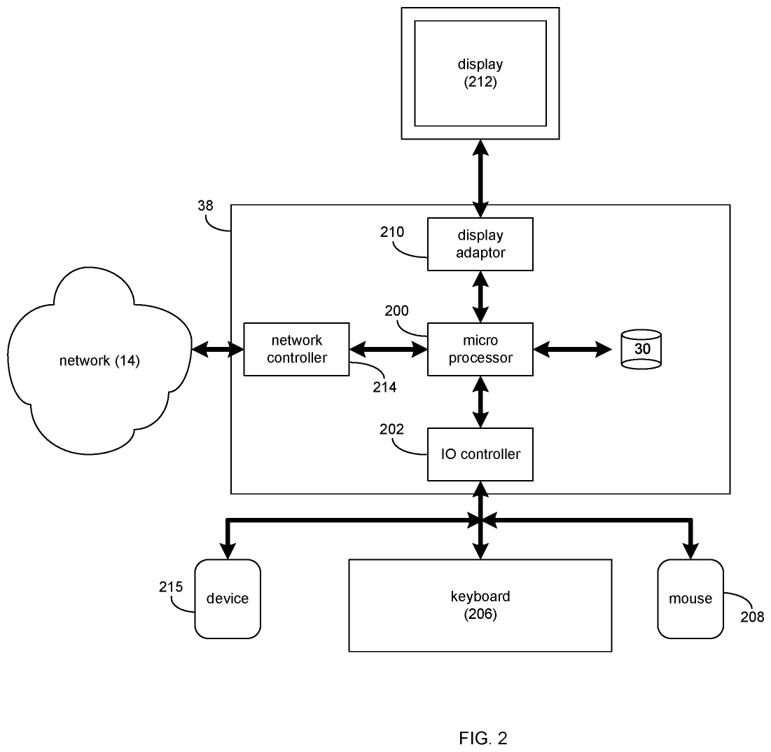

Referring also to the example implementation of FIG. 2, there is shown a diagrammatic view of client electronic device 38. While client electronic device 38 is shown in this figure, this is for example purposes only and is not intended to be a limitation of this disclosure, as other configurations are possible. Additionally, any computing device capable of executing, in whole or in part, the accuracy improvement process 10 may be substituted for client electronic device 38 (in whole or in part) within FIG. 2, examples of which may include but are not limited to computer 12 and/or one or more of client electronic devices 38, 40, 42, 44.

In some implementations, client electronic device 38 may include a processor and/or microprocessor (e.g., microprocessor 200) configured to, e.g., process data and execute the above-noted code/instruction sets and subroutines. Microprocessor 200 may be coupled via a storage adaptor to the above-noted storage device(s) (e.g., storage device 30). An I/O controller (e.g., I/O controller 202) may be configured to couple microprocessor 200 with various devices, such as keyboard 206, pointing/selecting device (e.g., touchpad, touchscreen, mouse 208, etc.), custom device (e.g., device 215), USB ports, and printer ports. A display adaptor (e.g., display adaptor 210) may be configured to couple display 212 (e.g., touchscreen monitor(s), plasma, CRT, or LCD monitor(s), etc.) with microprocessor 200, while network controller/adaptor 214 (e.g., an Ethernet adaptor) may be configured to couple microprocessor 200 to the above-noted network 14 (e.g., the Internet or a local area network).

The client electronic device 38 may include a wide variety of I/O devices. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers.

The client electronic devices 38, 40, 42, 44 may include a combination of multiple input or output devices, including, e.g., Microsoft KINECT, Nintendo Wiimote for the WII, Nintendo WIT U GAMEPAD, or Apple IPHONE. Some client electronic devices 38, 40, 42, 44 may allow gesture recognition inputs through combining some of the inputs and outputs. Some client electronic devices 38, 40, 42, 44 may provide for facial recognition which may be utilized as an input for different purposes including authentication and other commands. Some client electronic devices 38, 40, 42, 44 may provide for voice recognition and inputs, including, e.g., Microsoft KINECT, SIRI for IPHONE by Apple, Google Now or Google Voice Search.

Additional client electronic devices 38, 40, 42, 44 may have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices.

As will be discussed below, an accuracy improvement process 10 may at least help, e.g., improve existing technology, necessarily rooted in computer technology to overcome an example and non-limiting problem specifically arising in the realm of ASR systems and the practical application associated with, e.g., improving classification. It will be appreciated that the computer processes described throughout are integrated into one or more practical applications, and when taken at least as a whole are not considered to be well- understood, routine, and conventional functions.

### The Accuracy Improvement Process:

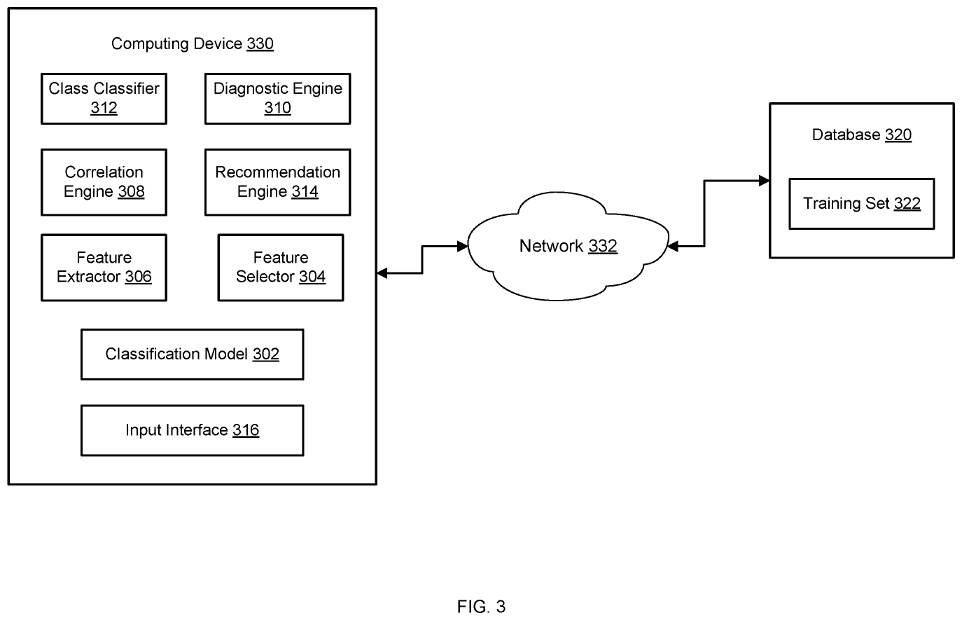

As discussed above and referring also at least to the example implementations of FIGS. 3-6, an example accuracy improvement process 10 is shown. For example, FIG. 3 shows a block diagram of a system 300 for assisting a developer in improving an accuracy of a classification model in accordance with an example embodiment of the disclosure. The system 300 may be configured to automatically generate diagnostic examples which can be verified by the developer and thus can indicate a decision-making process of a classification model. As a result, the system 300 may enable the developer to address imbalanced distribution of examples in the training set before release of the training set and the system 300 to production.

The system 300 may be configured to include a computing device 330 (e.g., one of the client electronic devices 38, 40, 42, 44 and/or computer 12 of FIG. 1). The computing device 330 may comprise a classification model 302, a feature selector 304, a feature extractor 306, a correlation engine 308, and a diagnostic engine 310. The computing device 330 may be configured to communicatively couple to a database 320 to access a training set 322 through a network 332. The network 332 may be a collection of individual networks, interconnected with each other and functioning as a single large network. Such individual networks may be wired, wireless, or a combination thereof. Examples of such individual networks include, but are not limited to, Local Area Networks (LANs), Wide Area Networks (WANs), Metropolitan Area Networks (MANs), Wireless LANs (WLANs), Wireless WANs (WWANs), Wireless MANs (WMANs), the Internet, second generation (2G) telecommunication networks, third generation (3G) telecommunication networks, fourth generation (4G) telecommunication networks, and Worldwide Interoperability for Microwave Access (WiMAX) networks.

The classification model 302 may include a plurality of features corresponding with a set of classes. One or more features among the plurality of features correspond with at least one class of the set of classes. A feature may be defined as indicating a value that may be derived or computed from an input by an algorithm. An example of features may be values that are computed as intermediate values by a classifier during a classification process. In this example, some of these intermediate values may be used by the classifier to determine a particular class (e.g., specific combination of words relates to sports class or specific combination of image data relates to cow image class).

In an example embodiment, the computing device 330 may be configured to include a class classifier 312 to determine the at least one class of the set of classes. For example, a classifier may be a system/module/algorithm that accepts an input (e.g., typically multi-dimensional data such as text, image, video, audio, instrumental measurement, data, etc.) and may output an integer number in a pre-defined range of discreet values. The output value may be then interpreted as indicating to which class the input belongs (e.g. an input image is classified as an image class that may contain one of a set of pre-defined objects such as dog class, cow class, boat class, etc.). In another example, the classifier may be used to identify that a dialogue relates to a specific class (e.g., sentence relates to restaurant class, sports class, car class, etc.).

In an example embodiment, the classification model 302 may be created from a provided training set 322. Alternatively, the classification model 302 may be a pre-trained model. In an example embodiment, the classification model 302 may be a neural network-based classification model. In an example, the classification model 302 may be implemented as a neural network. In other examples, the classification model may be implemented as a support vector machine (SVM), decision trees, random forests, logistic regression, and the like.

In an example embodiment, each feature may comprise a word, a part of a word, a phrase, a sentence, a paragraph, a combination of words, a portion of an image, a portion of an audio, a portion of a video, a portion of data, and a combination thereof.

The feature selector 304 may be configured to select one or more features of the plurality of features and the feature extractor 306 may be configured to extract values for the selected one or more features. For example, having access to all the intermediate values which may be calculated by the classifier during the classification process, the feature selector 304 may select a part of these values to be considered for the generation of diagnostic examples. In an example embodiment, the feature selector 304 may be configured to select positions of the respective one or more features within a neural network-based classification model 302 (e.g., positions such as specific layers in the neural network may be selected). In an example embodiment, filters (e.g., receptive fields) learned by a lowest layer of the neural network may be examined to determine words/word combinations which the classification model 302 found to be important for classification (e.g., important based on correlation). In another example embodiment, the feature selector 304 may be configured to receive an input from a developer regarding the selection of the one or more features so that the one or more diagnostic examples may be generated as per the inputs of the developer.

The correlation engine 308 may be configured to determine at least one correlation of the selected one or more features with the set of classes respectively. In some examples, the correlation engine 308 may determine multiple correlations and may select a correlation among the multiple determined correlations. In an example embodiment, the correlation engine 308 may be configured to use a neural network (e.g., such as a convolutional neural network) for determining the at least one correlation and then may use the neural network to select the correlation used for generating at least one diagnostic example. In another example embodiment, the correlation engine 308 may be configured to extract the at least one correlation or multiple correlations from the classification model 302. In an example with multiple correlations, the correlation engine 308 may be configured to extract the correlations from the classification model 302, and then may select the correlation used for generating at least one diagnostic example. In a specific example of this, at least one correlation may be directly extracted from a neural network (e.g., such as a convolutional neural network) as paths from features to output network nodes which are associated with highest weights. For example, the neural network (e.g., convolutional neural network) may have been trained for the intent classification example of “where” being associated with “pizza”. Further, the neural network may learn a convolutional filter corresponding to the word “where” has weights connecting this filter to the class “pizza” that are among the highest. The correlation engine may detect this automatically and may select the correlation between “pizza” and “where” for the generation of the diagnostic example.

In an example embodiment, the correlation engine 308 may be configured to determine the correlation based on an absolute frequency of occurrence of the feature or a relative frequency of occurrence of the feature corresponding to each class. For example, the correlation engine 308 may be configured to use N (e.g., any number of) most frequent words to determine an intent of the feature when the classification model 302 is an intent classifier. Subsequently, the diagnostic example may indicate the correlation between the feature and the identified intent as rendered to the developer. In an example embodiment, the correlation engine 308 may be configured to select the correlation based on a highest correlation value. For example, the correlation engine 308 may be configured to use the most frequent words to determine the correlation of an intent with the feature when the classification model 302 is an intent classifier. Subsequently, the diagnostic example may indicate the correlation between the feature and the identified intent as rendered to the developer. In an example embodiment, the correlation engine 308 may be configured to select the correlation based on a highest correlation value. For example, this correlation may be calculated using a “Pearson” correlation formula on the values of the feature and an indicator function which is one (1) when the input belongs to the considered class, and zero (0) otherwise. For example, the correlation engine may calculate a “Pearson” correlation of 1.0 for the occurrence of the word “where” in examples of intent “pizza” class, and a correlation of 0.1 for the word “me” in examples of the intent “pizza” class. Based on this, the correlation engine 308 may then choose the correlation between “where” and “pizza” as having highest correlation value.

In an example embodiment, the correlation engine 308 may be configured to compute the one or more correlations over a set of examples. For example, the correlation engine 308 may be configured to use term frequency and inverse document frequency (TF/IDF) and may calculate word count statistics (e.g., occurrences of single words, or co-occurrences of several words, or word embeddings) for each intent separately. Subsequently, the correlation engine 308 may be configured to compare distributions of these statistics across the different intents. Each element (word/word combination) whose statistics are significantly different in one intent than in other intents (e.g., when the value may be above or below specified thresholds), may be a candidate diagnostic example. Subsequently, the diagnostic engine 310 may be configured to determine thresholds and/or rankings to present the diagnostic example to the developer.

In an example embodiment, the diagnostic engine 310 may be configured to determine for a given sentence, what part of the sentence may be especially contributing to the activation of a specific neuron (e.g., by removing one element of the input at a time, to see how the activation of the target neuron changes) for highlighting within the diagnostic example in a neural network-based classification model 302. In one example, the given sentence may be “where is a good place for coffee” (which may be misclassified as a “pizza” intent by the intent classifier because of the word “where”). The diagnostic engine 310 may create one or more partial sentences from the given sentence by removing at least one word from the given sentence as shown below:

| Partial sentences | Confidence Scores | Omitted Word |
|---|---|---|
| “is a good place for coffee” | 0.4 | “where” |
| “where a good place for coffee” | 0.7 | “is” |
| “where is good place for coffee” | 0.8 | “a” |
| “where is a place for coffee” | 0.82 | “good” |
| “where is a good place coffee” | 0.79 | “for” |
| “where is a good place for” | 0.83 | “coffee” |

The diagnostic engine 310 may run an intent classifier on multiple partial sentences and may record the confidence scores the classifier may give for each of these partial sentences as belonging to the “pizza” intent as shown above for example. The diagnostic engine 310 may output the original sentence (e.g., “where is a good place for coffee”), e.g. with a different text background for each word, with higher emphasis for words whose omission received a lower classifier confidence score. For example, omitting the word “where” may result in high drop in confidence score. The given sentence may be taken from the training set or provided by the developer.

The diagnostic engine 310 may be configured to generate the at least one diagnostic example for the selected correlation, where the at least one diagnostic example may require the developer to validate or invalidate a correctness of the selected correlation represented by the at least one diagnostic example. In an example embodiment, the diagnostic engine 310 may be configured to iteratively generate another diagnostic example for the developer for another correlation selected from the determined correlations. For example, this other diagnostic example may require the developer to validate or invalidate the correctness of another correlation represented by another diagnostic example. For example, the diagnostic example may be the following statement: “the sentence composed of the single word ‘where’ has the intent ‘pizza’ class”. The developer may give feedback (e.g. “yes” or “no”) to indicate if this is a valid or invalid statement (e.g., regarding correlation of “where” with “pizza” class). The system may then proceed to a next selected correlation and may generate another diagnostic example. For example, the next selected correlation may be the word “cheese” with the intent “pizza” class. Another diagnostic example may be the following statement: “the sentence composed of the single word ‘cheese’ has the intent ‘pizza’ class”.

In an example embodiment, the diagnostic engine 310 may be configured to generate at least a text-based question, at least an image-based question, at least an audio-based question, at least a video-based question, and at least a data-based question (e.g., numeric or relational data-based question) for the developer to validate or invalidate the correctness of the correlation produced (e.g., selected correlation). For example, the image-based question may include a part of an image with only water and a question (e.g., “is this a boat?”) for the developer. The diagnostic example may indicate to the developer that the classification model 302 has learned to recognize water in the image as the boat. The developer may invalidate the correlation between the water and the boat (e.g., signal that correlation is false or incorrect through different types of inputs). Similarly, the text-based question may include a question (e.g., “It looks like the word ‘where’ indicates a pizza intent—is this correct?”). This diagnostic example may indicate to the developer that the classification model 302 has learned to recognize “where” as the pizza intent. Subsequently, the developer may invalidate the correlation between the word “where” and its respective intent (e.g., pizza). Where the diagnostic example may indicate to the developer that the classification model 302 has learned to recognize “cheese” as the “pizza” intent, the developer may validate this correlation with “pizza” intent.

For a data-based question, an example may relate to a user that buys a type of object (e.g., regularly buys old cars, antique chairs, etc.). The user may receive offers to buy objects of these types such as chairs. These offers may be received in various forms of modalities or mediums such as email, text, voice, website, etc. For each offer, there may be a set of attributes that may describe the offer (e.g., these attributes may be described as one section of a data table such as a column or row of a structured query language (SQL) (or similar) database with multiple fields where each field may be of different types such as integer, floating-point, enumeration, and other types). Most relevant, the input to the classifier may be data such as structured data. The defining property of the structured data may be that it is unambiguous (e.g., input may refer to color, price, age, etc.), and the value of the input may be unambiguously readily available (e.g., green (color), $12 (price), 29 (age), etc.). This may relate to unstructured data such as images, audio, text, etc. For example, for an antique chair, there may be various attributes or features such as, e.g., age, color, weight, style, condition, price, etc. The buyer may then decide whether to buy the object (e.g., chair) or not. The accuracy improvement process 10 may get an offer and may decide if there is a chance the buyer may be interested (e.g., a classifier filter may be used to determine if buyer may be “interested” or “not interested” based on correlations). In this example, the classifier or classifier filter may be deciding between these two classes: “interested” or “not interested” since the classifier may serve as a filter for buying offers. The correlation may be between a feature (e.g., color) and a class (e.g., “interested” or “not interested”). Given the offers the buyer received in the past and the buyer's decision for each offer, the accuracy improvement process 10 may train the classification model 302 over time based on the stored historical data of the buyer. The accuracy improvement process 10 may then improve the classification model 302 by going through the same above-described accuracy improvement process 10 for generating the diagnostic examples. In this example, the buyer may be interested in buying a type of object such as chairs where all offers may be for chairs only. By chance, the buyer may say yes to all green chairs. In summary, from historical data, the buyer may have bought a relatively significant number of green chairs. Thus, the accuracy improvement process 10 may generate the following data-based question such as “looks like you buy green chairs, is this correct?” where “green” may be a correlation with the class “interested”. This may be done with other objects such as cars, books, clothes, etc. If the user (e.g., buyer) invalidates this correlation as presented by the data-based question, the accuracy improvement process 10 may add (manually or automatically) examples to the training set to adjust the classification model 302 accordingly. In this data-based question example, the user may be part of training/improving classification model over time.

In an example embodiment, the diagnostic engine 310 may be configured to access one or more examples within a training set 322, may extract one or more features (e.g., a word such as a specific word in a sentence such as “where” or “cheese”, a part of a word, a phrase, a sentence, a paragraph, a combination of words, a portion of an image such as background color and/or specific shapes in image, a portion of an audio, a portion of a video, and a portion of data, etc.) for each example of the one or more examples, and may generate the at least one diagnostic example in accordance with the extracted features. For example, with audio or portion of audio, a dial tone audio may be detected as present due to its frequency signature (e.g., presence of specific frequencies at specific time slide of audio). Also, another audio example may be the detection of sound vs. silence. For a video example (e.g., portion of video), a slice of video may be a color such as blue (e.g., presence of specific colors at specific time slide of video) which may indicate or correlate with sky or water (e.g., blue in upper part of video may be correlated as sky whereas blue in lower part of video may be correlated as water). In addition, the diagnostic engine 310 may be configured to generate samples/examples in order from strongest confidence to lowest confidence. For example, an image classifier may run on an input image (e.g., image 1), and the values of a set of features (e.g., feat-set) may correspond to an intermediate layer of a neural network (e.g., convolutional neural network) may be saved (e.g., saved as feat-vall). Next, an iterative optimization process may be executed that starts with a new randomly initialized input image (e.g., image2). At each iteration, the neural network may be applied to calculate feat-set on image2 (e.g., feat-va12). An error back-propagation algorithm may be applied to the difference between feat-vall and feat-va12. After the back-propagation algorithm may be applied, image2 may be updated in proportion to the back-propagated error gradient (e.g., image3) such that the extracted feat-set from image3 (e.g., feat-va13) may be closer than feat-va12 to feat-vall. In this example, a neural network type of classifier (e.g., convolutional neural network classifier) may be used to classify images as either a boat or a cow. The classifier may wrongly learn that blue background (e.g., extracted feature) means boat and green background (e.g., extracted feature) means cow. Thus, at some part of the neural network, at least one feature corresponding to the background color may be computed (e.g., feat-set). When the system runs the classifier on an image of a boat in water, the value of the extracted feat-set (e.g., feat-va11) may correspond to blue-background. A new image (e.g., image2) may be initialized randomly, and then the iterative optimization process described above may be run. After each iteration of the back-propagation, image2 may be updated such that its background becomes more blue (e.g., aligning the color of image2 to the blue color of image1). Extracting feat-set from the updated image2 may give values relatively close to feat-vall (e.g., both images may have similar backgrounds). The system may then display to the developer a blue image and ask if the blue image is a boat. The developer may then invalidate this correlation of a blue image being a boat.

The computing device 330 may further include an input interface 316 (e.g., via input devices such as keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors) for receiving an input (e.g., haptic, voice, or the like) from the developer that validates or invalidates (e.g., validates simply means an input of “yes” and invalidates simply means an input of “no” in any form whether through speech or haptic) the correctness of the selected correlation in response to the at least one diagnostic example.

In an example embodiment, the diagnostic engine 310 may be configured to generate diagnostic examples (e.g., in the form of full sentences, images, video, data, etc.). These diagnostic examples may be verified by the developer and/or point to specific patterns which are relatively strong indicators for a specific intent(s) when the system 300 may be configured as an intent classifier. As an example, without limitation, the system 300 may be configured to determine two example intents namely: e.g., “find a restaurant” and “find a bookstore”. Assuming the developer invalidates one or more correlations for the example intents—e.g., the developer invalidates the correlation between the word “where” and the intent “restaurant”. Accordingly, the developer may then provide the following sentences to be added to the training set 322 for improving accuracy of the intent classifier (e.g., add example sentences with the word “where” to the bookstore intent, and/or add example sentences without the word “where” to the restaurant intent sentences), e.g.,:

1) For the restaurant intent:

Do you know a good place to eat?

I'm looking for a pizza.

2) For the bookstore intent:

Show me where the closest bookstore is located.

Where is a nearby bookstore?

With this input to the machine learning training algorithm, the system 300 may learn to successfully recognize the intent for these sentences. The methods and systems described in the present disclosure may enable the diagnostic engine 310 to generate a diagnostic example disclosing that e.g., “I see that ‘where’ is strongly correlated with restaurant—is that correct?” (e.g., using confirmation). The developer may indicate that this is not a correct correlation (e.g., via a user interface) with restaurant intent. As a result of invalidation by the developer, the system 300 may be configured to generate examples where correlation of “where” is accurately computed for other intents (e.g., bookstore intent). In an example, the system 300 may be configured to generate sentences for the bookstore intent which contain the word “where” as shown above. These examples when added in the training set 322 may substantially increase the accuracy of the classification model 302. In other examples, as a result of invalidation by the developer, the system 300 may be configured to generate examples excluding “where” (i.e., without “where”) for the restaurant intent which may also substantially increase accuracy of the classification model 302. Based on the invalidation of “where” with restaurant intent, when the diagnostic engine 310 may generate another new diagnostic example for the restaurant intent, the diagnostic example may exclude “where” from the generated diagnostic example.

In another example embodiment, the diagnostic engine 310 may be configured to highlight the selected correlation in the diagnostic example rather than generating a textual question for the validation of the selected correlation in the diagnostic example. The highlighted section in the diagnostic example may enable the developer to understand the decision process of the classification model 302 in a relatively simple format and efficient manner. For example, the diagnostic engine 310 may highlight the word “where” in the sentence “where can I get pizza?”. This may alert the developer that the classification model 302 learned the wrong correlation, and subsequently, the system 300 may be configured to suggest one or more remedies.

Optionally, the system 300 may be configured to include a recommendation engine 314. The recommendation engine 314 may be configured to recommend the developer to provide an additional set of plurality of examples used as training data for adjusting the classification model 302 to suppress the selected correlation between the selected one or more features and the set of classes when the developer invalidates the correctness of the selected correlation. In an example embodiment, the recommendation engine 314 may be configured to automatically generate an additional set of plurality of examples used as training data for adjusting the classification model 302 to suppress the selected correlation between the selected one or more features and the set of classes when the developer invalidates the correctness of the selected correlation.

As an example and without limitation, when the developer indicates that the diagnostic example is a false example (e.g., the diagnostic example does not belong to the intent as indicated by the system 300), the recommendation engine 314 may be configured to automatically and/or semi-automatically generate additional samples/examples that may balance the training set 322 and thereby shift the classification model 302 in correct direction in terms of the correlation. For the pizza example, where the word “where” is correlated with pizza (which the developer invalidates), the recommendation engine 314 may be configured to generate sentences for the “bookstore intent” which include the word “where” (e.g., “where is the closest bookstore?”) to balance the training set 322 and shift the classification model 302 in the correct direction in terms of the correlation.

In an example, a computer implemented method (e.g., accuracy improvement process 10 or simply process 10) for assisting a developer in improving an accuracy of the classification model 302 in accordance with an example embodiment of the disclosure is discussed. The process 10 may be configured to provide the classification model 302 including a plurality of features corresponding with a set of classes, where one or more features may correspond with at least one class of the set of classes. The process 10 may be configured to select one or more features of the plurality of features and may extract values for the selected one or more features. The process 10 may be configured to determine at least one correlation of the selected one or more features with the set of classes respectively. In some examples, where multiple correlations are determined, a correlation may be selected among the multiple determined correlations. Further, the process 10 may be configured to generate at least one diagnostic example for the selected correlation in a manner such that the at least one diagnostic example may require a developer to validate or invalidate a correctness of the selected correlation produced or represented by the at least one diagnostic example.

In an example embodiment, the process 10 may be configured to receive an input from the developer on the validity of the at least one diagnostic example. The developer through the input may either validate or invalidate the correctness of the selected correlation in response to the at least one diagnostic example.

In an example embodiment, the process 10 may be configured to recommend the developer to provide an additional set of examples used as training data for adjusting the classification model 302 to suppress the selected correlation between the selected one or more features and the set of classes when the developer invalidates the correctness of the selected correlation. Subsequently, the process 10 may be configured to receive the additional set of examples.

In an example embodiment, the process 10 may be configured to automatically generate the additional set of examples that may be used as training data for adjusting the classification model 302 to suppress the selected correlation between the selected one or more features and the set of classes, when the developer invalidates the correctness of the selected correlation. Further, the process 10 may be configured to recommend the developer to revise and/or approve the additional set of examples such that the examples may be used as training data for adjusting the classification model 302 to suppress the selected correlation between the selected one or more features and the set of classes.

In some implementations, the process 10 may be configured to adjust the classification model 302 by modifying at least one parameter of the classification model 302 in a manner such that modification of the at least one parameter may suppress the selected correlation between the selected one or more features and the set of classes. Subsequently, the process 10 may be configured to re-determine the at least one correlation of the selected one or more features upon adjusting the classification model 302. For example, when the developer indicates that the correlation is incorrect, the system 300 may allow for modification of the classification model 302 either directly (e.g., by modifying model parameters) or indirectly (e.g., by adding new sentences to the training data such that the model is retrained using the augmented training set 322) which may help shift model in a correct direction in terms of correlation.

In an example embodiment, the process 10 may be configured to lower the weights associated with a correlation which the developer flagged as being false while modifying the parameters of the neural network classification model 302.

In an example embodiment, the process 10 may be configured to locate existing examples in the training set 322 where the flagged correlation is incorrect. For this example, the developer may perform only minor changes to turn the examples into quality new training examples. In the Pizza example, the system 300 may pull up all sentences which had the false correlation (e.g., “where” means pizza is false correlation)—for example “where can I find a pizzeria”. For this example, the developer may only need to change one word (e.g., change “pizzeria” to “bookstore”) such that the example sentence may be: “where can I find a bookstore” (from “where can I find a pizzeria”).

In an example embodiment, the modification of the classification model 302 may be completely automatic, semi-automatic (e.g., human supported by tools to automate parts of the task), or completely manual (e.g. developer providing new sentences).

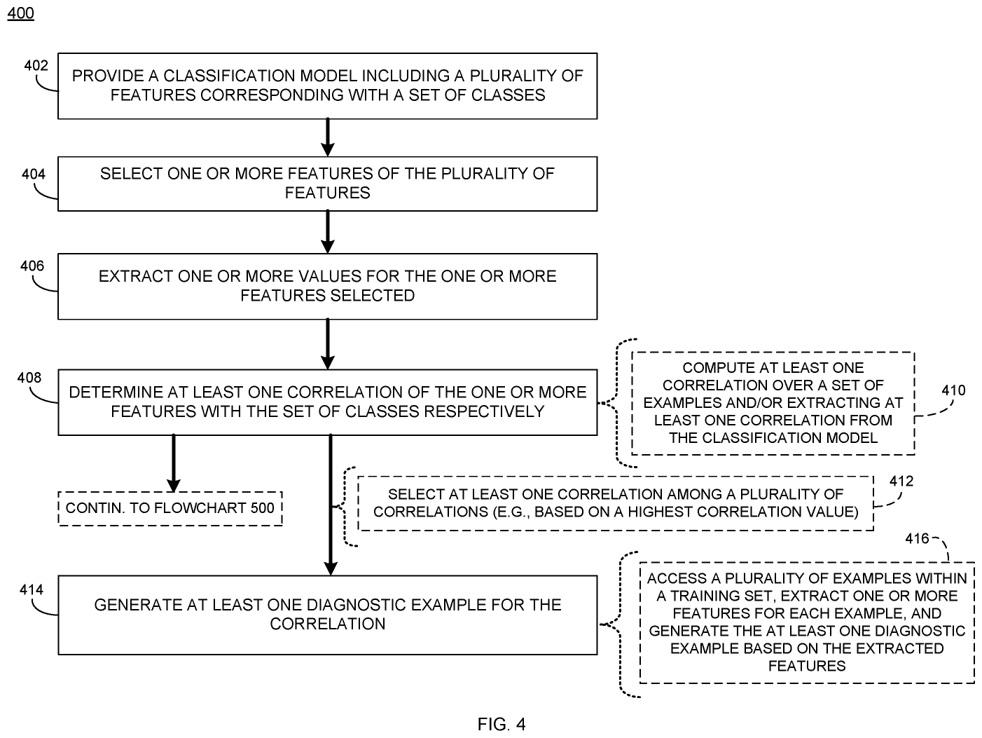

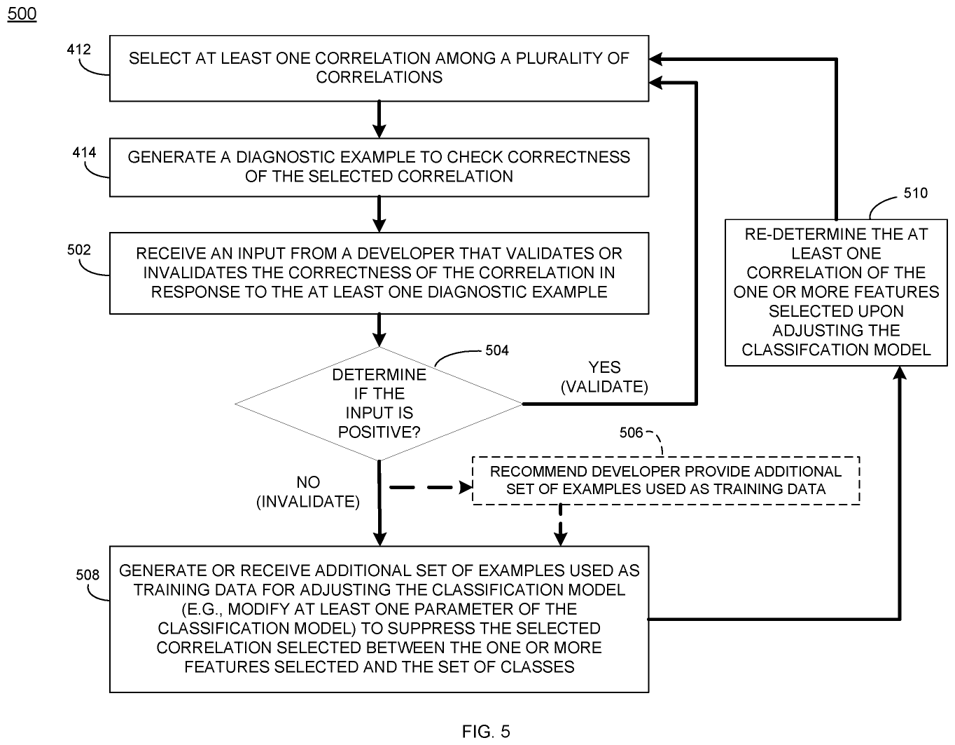

In an example embodiment, a computer implemented method (e.g., accuracy improvement process 400 also referred to above as the accuracy improvement process 10 or process 400 may be a part of the accuracy improvement process 10) is shown in the example implementation of FIG. 4. FIG. 4 is a flowchart of the accuracy improvement process 400 (e.g., executed by accuracy improvement process 10) for assisting a developer in improving an accuracy of the classification model 302 in accordance with an example embodiment of the disclosure. In one example aspect, the accuracy improvement process 10 may provide 402 a classification model including a plurality of features corresponding with a set of classes. One or more features may correspond with at least one class of the set of classes. The classification model may be provided by a developer or user via an electronic device or may be stored such that the classification model may be provided automatically by the accuracy improvement process 10. The accuracy improvement process 10 may select 404 one or more features of the plurality of features. In some examples, selecting 404 one or more features may be based on, at least in part, a location of the one or more features in a neural network (e.g., selecting one feature over another feature based on location of the selected feature in a neuron of the neural network). For example, each feature relates to at least one neuron in the neural network and each neuron calculates correlation (e.g., “Pearson” correlation) for feature of the respective neuron. A neural network may perform a complex calculation by repeatedly composing multiple simple calculations where each calculation (e.g., simple or composition) may be carried out by a neuron (which may correspond to a location in the network). Each neuron may correspond to an intermediate calculation (and the result of this calculation, for a given input). This resulting calculation may be used as and correspond with a feature for the purpose of calculating the correlation of that feature. Thus, one feature may be selected over another feature based on this correlation calculation and thus the location of the feature in the neural network. In other examples, selecting 404 one or more features may be based on, at least in part, a received input selection from the developer (e.g., this user input may refer to the user manually inputting a selection of one or more features to be used for correlation). For example, the user may limit the range of features to be considered for correlations. Accuracy improvement process 10 may extract 406 one or more values for the one or more features selected. The accuracy improvement process 10 may determine 408 at least one correlation of the selected one or more features with the set of classes respectively. In some examples, determining 408 at least one correlation may include the accuracy improvement process 10 computing 410 at least one correlation over a set of examples and/or extracting at least one correlation from the classification model. For example, with the pizza example, the correlation over the set of examples may refer to a correlation between single words and a class/intent (e.g., percentage of 95% of times the word “where” may appear, the intent/class may be “pizza”). For the correlation from the classification model, in some examples, a neural network may include relative connection weights between neurons as being related to a correlation. For example, if weights of inputs into a specific neuron A may be all low except for one input with a high weight (e.g., from neuron B), then the value of neuron A may be correlated with that of neuron B (e.g., when neuron B may be high). This may occur with neuron A when neuron A may have a high weight. If such a chain may be found from the input layer to the output layer of the neural network, then the accuracy improvement process 10 may conclude that that there is a correlation between the input (e.g., “where” calculated at neuron B as being high weight) and class/intent (e.g., “pizza”). In some examples, where multiple correlations are determined, the accuracy improvement process 10 may select 412 at least one correlation among a plurality of the determined correlations (e.g., based on a highest correlation value). Accuracy improvement process 10 may generate 414 at least one diagnostic example (e.g., text-based question, image-based question, audio-based question, video-based question, or data-based question) for the selected correlation, where the at least one diagnostic example may require the developer to validate or invalidate a correctness of the selected correlation produced or represented by the at least one diagnostic example. The generating 414 of at least one diagnostic example may include the accuracy improvement process 10 accessing 416 a plurality of examples within a training set, extracting one or more features for each example, and generating the at least one diagnostic example based on and in accordance with the extracted features. In some examples, the accuracy improvement process 10 may determine 408 the at least one correlation and may continue to accuracy improvement process 500 as shown in a flowchart in FIG. 5.

In some example embodiments, the accuracy improvement process 500 may be a computer implemented method (e.g., accuracy improvement process 500 also referred to above as the accuracy improvement process 10 or process 500 which may be a part of the accuracy improvement process 10) that is shown in the example implementation of FIG. 5. FIG. 5 is the example flowchart of the accuracy improvement process 500 for adjusting the classification model 302 in accordance with an example embodiment of the disclosure. As described above, the accuracy improvement process 500 may include selecting 412 at least one correlation among the multiple determined correlations for accuracy improvement process 500. Also, the accuracy improvement process 500 may include generating 414 a diagnostic example to check correctness of the selected correlation. Accuracy improvement process 10 may receive 502 an input from a developer that validates or invalidates the correctness of the correlation in response to the at least one diagnostic example. The input may correspond to a validity or an invalidity of the selected correlation using the diagnostic example. Accuracy improvement process 10 may determine 504 if the input of the developer is a positive input (e.g., the developer may validate the correlation) or not a positive input which is a negative input (e.g., the developer may invalidate the correlation).

The process 500 may be configured to determine 504 whether the input of the developer is the positive input (e.g., validate), where if the input is a positive input, accuracy improvement process 10 may select 412 another correlation among the plurality of correlations. In general, in examples where the positive input or validation is received, the same correlation may be re-run again with new and different diagnostic examples generated for the same class or different class by the accuracy improvement process 10. Also, in some examples, after the positive input or validation, the accuracy improvement process 10 may be re-run for a new correlation for a same class or different class. The process 500 may be configured to determine 504 whether the input of the developer is not the positive input which is a negative input (e.g., invalidate), where if the input is a negative input, the process 500 may optionally be configured to recommend 506 that the developer provide an additional set of examples used as training data for adjusting the classification model. The accuracy improvement process 10 may automatically generate or receive 508 an additional set of examples used as training data for adjusting the classification model (e.g., modify at least one parameter of the classification model) to suppress the selected correlation between the one or more features selected and the set of classes in a manner as already discussed above in the disclosure. Accuracy improvement process 10 may re-determine 510 the at least one correlation of the one or more features selected upon adjusting the classification model 302. The process 500 may be configured to select 412 another correlation among the plurality of correlations.

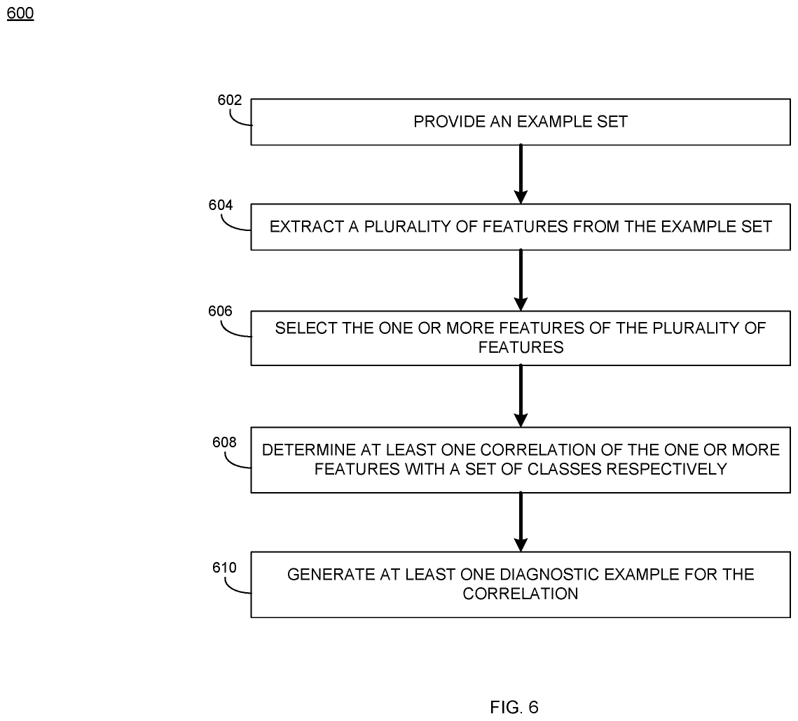

In some example embodiments, an accuracy improvement process 600 may be a computer implemented method (e.g., accuracy improvement process 600 also referred to above as the accuracy improvement process 10 or process 600 may be a part of the accuracy improvement process 10) that is shown in the example implementation of FIG. 6. FIG. 6 is the example flowchart of the accuracy improvement process 600 (e.g., executed by accuracy improvement process 10) for assisting a developer in improving an accuracy of a classification process in accordance with an example embodiment of the disclosure. In one example aspect, the accuracy improvement process 10 may provide 602 an example set. The accuracy improvement process 10 may extract 604 a plurality of features from the example set (where one or more features of the plurality of features correspond with at least one class of a set of classes). One or more features of the plurality of features may be selected 606 by the accuracy improvement process 10. The accuracy improvement process 10 may determine 608 at least one correlation of the one or more features selected with the set of classes respectively. In some examples, where multiple correlations are determined, the process 10 may be configured to select a correlation among the plurality of determined correlations. The accuracy improvement process 10 may generate 610 at least one diagnostic example for the correlation. The at least one diagnostic example may require the developer to validate or invalidate a correctness of the selected correlation produced or represented by the at least one diagnostic example.

The methods and systems described in the present disclosure offer several example and non-limiting advantages. The methods and systems described in the present disclosure may enable automatic inspection of the training set and the classifier model; and may render self-generating diagnostic examples for the developers so that the developers may increase accuracy of the classifier model. Further, when implemented for the intent recognizing systems, the methods described in the present disclosure may assist in controlling the quality of the intent recognizing systems.

The methods and systems described in the present disclosure may assist the developers to remove biased characteristics (which otherwise may not have been detected) within the training set. As a result, the methods and systems described in the present disclosure may enable the developers to detect several potential unintended errors before the classifier is released to end users. Further, the methods and systems described in the present disclosure may enable the developers to understand the cause of the inaccuracies exhibited by the classifier through the validation of the one or more diagnostic examples. Furthermore, the methods and systems described may be used as a tool by the developers of, e.g., chatbot applications and conversational agents.

The terminology used herein is for the purpose of describing particular implementations only and is not intended to be limiting of the disclosure. As used herein, the singular forms “a”, “an” and “the” are intended to include the plural forms as well, unless the context clearly indicates otherwise. As used herein, the language “at least one of A, B, and C” (and the like) should be interpreted as covering only A, only B, only C, or any combination of the three, unless the context clearly indicates otherwise. It will be further understood that the terms “comprises” and/or “comprising,” when used in this specification, specify the presence of stated features, integers, steps (not necessarily in a particular order), operations, elements, and/or components, but do not preclude the presence or addition of one or more other features, integers, steps (not necessarily in a particular order), operations, elements, components, and/or groups thereof.

The corresponding structures, materials, acts, and equivalents (e.g., of all means or step plus function elements) that may be in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications, variations, substitutions, and any combinations thereof will be apparent to those of ordinary skill in the art without departing from the scope and spirit of the disclosure. The implementation(s) were chosen and described in order to explain the principles of the disclosure and the practical application, and to enable others of ordinary skill in the art to understand the disclosure for various implementation(s) with various modifications and/or any combinations of implementation(s) as are suited to the particular use contemplated.

Having thus described the disclosure of the present application in detail and by reference to implementation(s) thereof, it will be apparent that modifications, variations, and any combinations of implementation(s) (including any modifications, variations, substitutions, and combinations thereof) are possible without departing from the scope of the disclosure defined in the appended claims.

1. A computer-implemented method for assisting a developer in improving an accuracy of a classification model, the computer implemented method comprising:
providing, by a computing device, the classification model including a plurality of features corresponding with a set of classes, wherein one or more features of the plurality of features correspond with at least one class of the set of classes;
selecting the one or more features of the plurality of features;
extracting one or more values for the one or more features selected;
determining at least one correlation of the one or more features with the set of classes respectively; and
generating at least one diagnostic example for the correlation;
wherein the at least one diagnostic example requires the developer to one of validate or invalidate a correctness of the correlation produced by the at least one diagnostic example.

2. (canceled)

3. (canceled)

4. (canceled)

5. (canceled)

6. The computer-implemented method as claimed in claim 1, wherein determining the at least one correlation includes at least one of computing the at least one correlation over a set of examples or extracting the at least one correlation from the classification model.

7. (canceled)

8. (canceled)

9. (canceled)

10. The computer-implemented method as claimed in claim 1, wherein the at least one diagnostic example includes at least one of: a text-based question, an image-based question, an audio-based question, a video-based question, or a data-based question for the developer to at least one of validate or invalidate the correctness of the correlation produced.

11. The computer-implemented method as claimed in claim 1, wherein generating the at least one diagnostic example comprises:
accessing a plurality of examples within a training set;
extracting the one or more features for each example of the plurality of examples; and
generating the at least one diagnostic example based upon, at least in part, the extracted features.

12. The computer-implemented method as claimed in claim 1, wherein each of the one or more features comprise at least one of a word, a part of a word, a phrase, a sentence, a paragraph, a combination of words, a portion of an image, a portion of an audio, a portion of a video, or a portion of data.

13. (canceled)

14. The computer-implemented method as claimed in claim 1, further comprising:
receiving an input from the developer that one of validates or invalidates the correctness of the correlation in response to the at least one diagnostic example;
when the developer invalidates the correctness of the correlation selected, at least one of:
recommending the developer provide an additional set of examples used as training data for adjusting the classification model to suppress the correlation selected between the one or more features selected and the set of classes; and receiving the additional set of examples;
automatically generating an additional set of examples used as training data for adjusting the classification model to suppress the correlation selected between the one or more features selected and the set of classes;
automatically generating an additional set of examples and recommending at least one of the developer revise or approve the additional set of examples such that the additional set of examples are used as training data for adjusting the classification model to suppress the correlation selected between the one or more features selected and the set of classes; or
adjusting the classification model by modifying at least one parameter of the classification model.

15. (canceled)

16. (canceled)

17. (canceled)

18. The computer-implemented method as claimed in claim 1 further comprising:
adjusting the classification model; and
re-determining the at least one correlation of the one or more features selected upon adjusting the classification model.

19. (canceled)

20. The computer-implemented method as claimed in claim 1, further comprising:
iteratively generating another diagnostic example for the developer for another correlation selected from the at least one correlation, wherein the another diagnostic example requires the developer to one of validate or invalidate the correctness of another correlation produced by the another diagnostic example.

21. (canceled)

22. A system for assisting a developer in improving an accuracy of a classification model, the system comprising:
the classification model including a plurality of features corresponding with a set of classes, wherein one or more features of the plurality of features correspond with at least one class of the set of classes;
a feature selector configured to select the one or more features of the plurality features;
a feature extractor for extracting one or more values for the one or more features;
a correlation engine configured to determine at least one correlation of the one or more features with the set of classes respectively; and
a diagnostic engine configured to generate at least one diagnostic example for the correlation;
wherein the at least one diagnostic example requires the developer to one of validate or invalidate a correctness of the correlation produced by the at least one diagnostic example.

23. The system as claimed in claim 22, wherein the diagnostic engine is further configured to:
iteratively generate another diagnostic example for the developer for another correlation selected from the at least one correlation, wherein the another diagnostic example requires the developer to at least one of validate or invalidate the correctness of another correlation produced by the another diagnostic example.

24. The system as claimed in claim 22, wherein the diagnostic engine is further configured to:
generate at least one of a text-based question, at least one image-based question, at least one audio-based question, at least one video-based question, or at least one data-based question for the developer to one of validate or invalidate the correctness of the correlation.

25. The system as claimed in claim 22, wherein each feature of the one or more features comprises at least one of a word, a part of a word, a phrase, a sentence, a paragraph, a combination of words, a portion of an image, a portion of an audio, a portion of a video, or a portion of data.

26. (canceled)

27. The system as claimed in claim 22, further comprising:
a recommendation engine configured, when the developer invalidates the correctness of the correlation selected, to at least one of:
recommend the developer to provide an additional set of a plurality of examples used as training data for adjusting the classification model to suppress the correlation selected between the one or more features selected and the set of classes when the developer invalidates the correctness of the correlation selected; and
automatically generate an additional set of a plurality of examples used as training data for adjusting the classification model to suppress the correlation selected between the one or more features selected and the set of classes when the developer invalidates the correctness of the correlation selected;
automatically generate an additional set of examples and recommending at least one of the developer revise and approve the additional set of examples such that the additional set of examples are used as training data for adjusting the classification model to suppress the correlation selected between the one or more features selected and the set of classes; or
adjust the classification model by modifying at least one parameter of the classification model.

28. (canceled)

29. A computer program product residing on a computer readable storage medium having a plurality of instructions stored thereon which, when executed across one or more processors, causes at least a portion of the one or more processors to perform operations for assisting a developer in improving an accuracy of a classification model comprising:
providing, by a computing device, the classification model including a plurality of features corresponding with a set of classes, wherein one or more features of the plurality of features correspond with at least one class of the set of classes;
selecting the one or more features of the plurality of features;
extracting one or more values for the one or more features selected;
determining at least one correlation of the one or more features with the set of classes respectively; and
generating at least one diagnostic example for the correlation;
wherein the at least one diagnostic example requires the developer to one of validate or invalidate a correctness of the correlation produced by the at least one diagnostic example.

30. The computer program product as claimed in claim 29, wherein determining the at least one correlation includes at least one of computing the at least one correlation over a set of examples or extracting the at least one correlation from the classification model.

31. The computer program product as claimed in claim 29, wherein the at least one diagnostic example includes one of at least one text-based question, at least one image-based question, at least one audio-based question, at least one video-based question, or at least one data-based question for the developer to one of validate or invalidate the correctness of the correlation produced.

32. The computer program product as claimed in claim 29, wherein generating the at least one diagnostic example comprises:
accessing a plurality of examples within a training set;
extracting the one or more features for each example of the plurality of examples; and
generating the at least one diagnostic example based upon, at least in part, the extracted features.

33. The computer program product as claimed in claim 29, wherein each of the one or more features comprise at least one of a word, a part of a word, a phrase, a sentence, a paragraph, a combination of words, a portion of an image, a portion of an audio, a portion of a video, or a portion of data.

34. The computer program product as claimed in claim 29, wherein the operations further comprise:
receiving an input from the developer that one of validates or invalidates the correctness of the correlation in response to the at least one diagnostic example;
when the developer invalidates the correctness of the correlation selected, at least one of:
recommending the developer provide an additional set of examples used as training data for adjusting the classification model to suppress the correlation selected between the one or more features selected and the set of classes and receiving the additional set of examples
automatically generating an additional set of examples used as training data for adjusting the classification model to suppress the correlation selected between the one or more features selected and the set of classes;
automatically generating an additional set of examples and recommending at least one of the developer revise and approve the additional set of examples such that the additional set of examples are used as training data for adjusting the classification model to suppress the correlation selected between the one or more features selected and the set of classes; or
adjusting the classification model by modifying at least one parameter of the classification model.

35. The computer program product as claimed in claim 29 wherein the operations further comprise:
adjusting the classification model; and
re-determining the at least one correlation of the one or more features selected upon adjusting the classification model.
